(19) United States
(12) Patent Application Publication
(10) Pub. No.: US 2009/0127183 A1
(43) Pub. Date: May 21, 2009

(54) Filter device

(76) Inventor: Viktor Lauer, Nalbach (DE)

Correspondence Address: Roylance Abrams Berdo & Goodman, 1300 19th Street NW Suite 600, Washington, DC, 20036, US

(21) Appl. No.: 11/990,929

(22) PCT Filed: Jul. 19, 2006
(86) PCT No.: PCT/EP2006/007075

§ 371 Date: Feb. 25, 2008

(30) Foreign Application Priority Data
Sep. 21, 2005 (DE) 10 2005 045 012.1

(51) Int. Cl. B01D 29/15; B01D 35/147

(52) U.S. Cl. 210/440

(57) ABSTRACT

The invention relates to a filter device with a housing (10) composed of at least two housing parts (12, 14) which are to be connected detachably to one another, said housing holding a filter element (26) which comprises a support tube (28) and a filter material (32) surrounding the support tube (28), wherein the ends (34, 36; 38, 40) of the support tube (28) and filter material (32) run into at least one holding part (42, 46; 44, 48). Since, according to the characterizing part of claim 1, the filter material (32) can be withdrawn in a direction (50) to separate it from the support tube (28) and since, in this direction (50) of withdrawal, the support tube (28) and the filter material (32) alike are provided with a predeterminable taper, it is possible for the contaminated filter material (32) to be readily withdrawn from the support tube (28) such that the support tube (28), together with its holding parts, can be reused in conjunction with a newly inserted filter material (32).

The invention relates to a filter device having a housing consisting of at least two housing parts which are to be detachably connected to one another, which housing holds a filter element which has a support tube and a filter material which surrounds the support tube, the ends of the support tube and the filter material discharging into at least one holding part.

Filter devices such as these are readily available on the market in a host of embodiments. The structure of the filter elements consisting of filter material and a support tube varies from manufacturer to manufacturer. For simple paper elements the filter materials are produced without supporting wire gauze, so that at higher pressure differentials the filter folds are pressed together on the filter elements. This reduces the drainage possibility for filter materials which have been folded in this way, so that consequently many folds remain unused for filtration. Conversely, higher quality elements have a multilayer filter material structure. This yields higher resistance of the elements to pressure peaks which may occur during filtration and to changing volumetric flows.

When the filter element has been used up, which is generally the case when the filter material is clogged by dirt, it is replaced in the housing by a new filter element. In the known solutions the filter element as a whole must then be disposed of, in the prior art suggestions already having been made to recycle parts of the filter element or to thermally incinerate them as a whole. In these solutions the support tube is likewise disposed of at the same time in this way, although it could be reused when cleaned directly or appropriately. The respective disposal of the entire filter element is in this case costly and accordingly also increases the amount of waste.

On the basis of this prior art, the object of the invention is to make available, while retaining the advantages in the prior art, specifically filter devices for which the filter elements in addition to high pressure differential stability and high dirt holding capacity, have filter finenesses for all cleanliness classes, and to further improve them such that when the filter element is replaced, in order to reduce costs, parts of the filter element can be reused. This object is achieved by a filter device with the features of claim 1 in its entirety.

In that, as specified in the characterizing part of claim 1, the filter material can be withdrawn in the direction separating it from the support tube and in that in this withdrawal direction both the support tube and also equally the filter material are provided with a definable taper, the fouled filter material can be easily withdrawn from the support tube, so that the latter, in conjunction with a newly inserted filter material, the support tube together with its holding parts can be reused. The correspondingly conical configuration of the support tube and filter material facilitate this separation, since in contrast to the known hollow cylindrical elements, in the described separation process the filter material does not interlock in the hole (perforation) of the support tube; this may not only make this separation difficult, but would make it completely impossible.

These considerations also apply to the new filter material being slipped onto the remaining support tube from the previous use in the filter housing of the filter device. In one preferred embodiment of the filter device according to the invention, provision is made such that the respective end of the filter material is provided with a holding part which has two ring segments which border the assigned end of the filter material on the inner and outer peripheral side respectively. By preference this bordering takes place by cementing, the inner peripheral-side ring segment being clearly reduced in wall thickness with the formation of a type of encompassing lip. In this way the described motion of sliding on and off when separating and reconnecting the filter material to the support tube takes place without further hindrance.

If the solution according to the invention is used in a so-called in-tank application in which parts of the filter device with the filter housing project into a fluid tank and remain there, the housing part which projects in this way, including the support tube insert and filter material, can be removed from the filter device, so that the retained and sedimented dirt is not flushed into the tank, but can be properly disposed of. Replacement of the filter material by new material with the subsequent process of slipping it onto the conical support tube can be done on site at a suitable maintenance location.

In another preferred embodiment of the filter device according to the invention, it is, however, also possible, in the area of the largest free cross section of the filter material together with the support tube, to provide the assignable holding part for the filter material with an annular holding space in the manner of a dirt catching basket, so that then for the remaining housing parts on the hydraulic system the filter material can be pulled off the support tube insert when fouled, then dirt which may have been retained and sedimented being able to settle in the indicated, molded-on dirt catching basket and its not being flushed into the hydraulic system, for example into the tank; this otherwise can lead to operating problems and failures of the entire hydraulic system.

Other advantageous configurations of the filter device according to the invention are the subject matter of the other dependent claims.

The filter device according to the invention will be detailed below using two embodiments as shown in the drawings. The figures are schematic and not to scale.

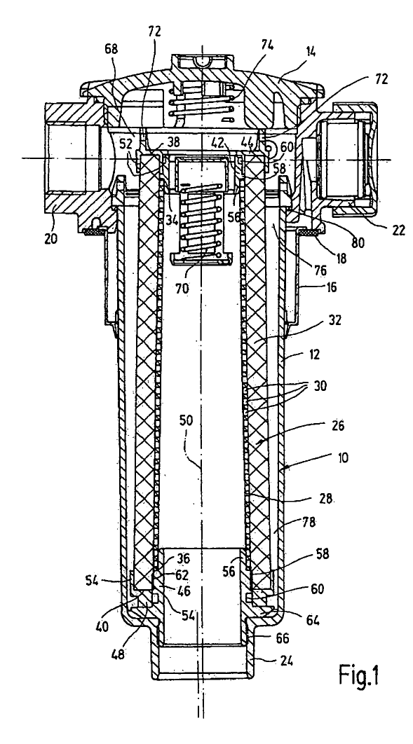

FIG. 1 shows a longitudinal section through a first embodiment of the filter device as a so-called in-tank solution and

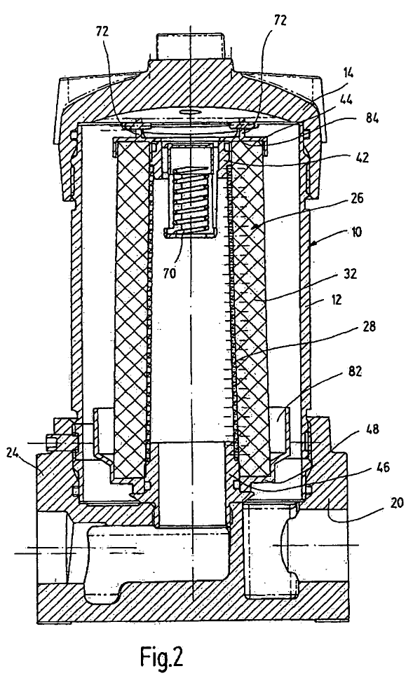

FIG. 2 shows a longitudinal section drawn accordingly to FIG. 1 through a second embodiment of the filter device according to the invention in which relevant housing parts remain on the hydraulic system in the process of replacement of the filter material.

The filter device as shown in FIG. 1 has a housing which is designated as a whole as 10. This housing 10 consists of at least two housing parts 12, 14 which are to be detachably connected to one another, the first housing part 12 being made in the manner of a filter casing, and the second housing part 14 forming a type of cover. The housing part 12 viewed in the direction of looking at FIG. 1 on its upper end is surrounded by an annular insertion flange 16 which has an annular bearing seal 18 for insertion into a fluid tank, which is not detailed, on its upper end. As further parts of the housing 10, viewed in the direction of looking at FIG. 1, on the left side an inflow connection 20 adjoins and on the right side a sealable connection site 22 adjoins, for example, for connection of a clogging indicator which is not detailed and which works, for example, based on measurement of the pressure differential. The housing 10 discharges on its bottom into an outflow connection 24.

This housing 10 in its interior holds a filter element which is designated as a whole as 26. This filter element 26 in the conventional manner on its inside has a support tube 28 with a plurality of passage sites 30 in the manner of a perforation. The support tube 28 is surrounded by a filter material 32 which consists preferably of several layers which yield a pleated, filter mat structure. This configuration of a filter element can be ascertained in the prior art so that it will no longer be detailed here. Viewed in the direction of looking at FIG. 1, the upper end 34 of the support tube 28 and also the upper end 38 of the filter material 32 each discharge into an assignable holding part 42 and 44, respectively. Likewise the lower end 36 of the support tube 28 and the lower end 40 of the filter material 32 discharge into the lower holding parts 46 and 48 respectively.

So that the filter material 32 can be withdrawn in the direction according to the longitudinal direction 50 of the housing 10 in separation from the support tube 28, in this withdrawal direction both the support tube 28 and also, to a certain extent, the filter material 32 are provided with a definable taper (cf. FIG. 1). Based on the conical configuration of the support tube 28, in addition to the filter material 32 in the form of a filter mat, frictionless separation from the filter material 32 to an assignable support tube 28 is possible without interlocking of the sensitive filter material 32 in the perforation 30 of the support tube 28 being possible. In this respect, a process of slipping new, unused filter material 32 onto the support tube 28 is possible, the indicated taper analogously supporting a defined slipping-on process of the indicated type and helping to facilitate the corresponding automation processes in assembly of the filter element 26. The remaining support tube 28 can be cleaned immediately, but also after a few replacement processes, for the filter material 32, for example, by means of the corresponding cleaning media and/or in an ultrasonic bath which is suitable for this purpose (not shown).

As FIG. 1 furthermore shows, both the upper holding part 44 and also the lower holding part 48 of the filter material 32 are provided with two ring segments 52 and 54. The respective ring segments 52, 54 encompass the assigned filter material end 38 and 40 on the outer and inner peripheral side respectively. The respective holding parts 44, 48 for the filter material 32 in this way form end caps and a seamless transition is formed between the filter material 32 and the support which has been formed in this way by the end caps which can be molded on in the form of the upper holding part 44 and of the lower holding part 48. The indicated seamless transition can be achieved by a conventional mirror welding process, via mold casting, a cement connection or the like. As a result of the elasticity of the filter material 32 used, it is especially possible for the two ring segments 52, 54 of one holding part 44 and 48 respectively to encompass the assigned filter material 32 by clamping at this site.

The ends 34, 36 of the support tube 28, as already described, are held in a holding part 42 and 46 which are independent thereof. Furthermore, viewed in the longitudinal direction 50 of the housing 10, the filter material 32 with its holding parts 44, 48 is axially longer than the support tube 28 which lies inside. Furthermore, provision is made such that the respective other holding part 42 with an annular flange-like extension 56 on the inner peripheral side supports the respectively free end area of the support tube 28, the ends 34, 36 of the support tube 28 adjoining the respective other holding part 42, 46 flush, which part is provided for this purpose with an annular widening 58. In particular, the annular widening 58 of the upper, other holding part 42 which is the upper widening viewed in the direction of looking at FIG. 1 is used to support the adjacent filter material 32 in the radial direction, so that in this way a seamless transition or seamless guidance between the filter material 32 in the form of the filter mat and the upper, other holding part 42 is ensured. On the adjacently opposite side, the annular widening 58 which is offset in a step shape in this way forms a contact surface for the free end of the upper ring segment 52 which is located on the inner peripheral side. If, proceeding from the annular widening 58, the upper, other holding part 42 and the lower, other holding part 46 are lengthened, there is thus an annular channel 60 for holding a suitable sealing means, especially in the form of a conventional O-ring (not shown). Integration of the sealing means in the other holding parts 42, 46 for the support tube 28 yields a reliable seal which otherwise does not hinder the motion of pulling the filter material 32 on and off the support tube 28 with its holding parts 42, 46. Alternatively, in one embodiment which is not detailed, it can also be provided that the end caps, that is, the holding parts 44 and 48 of the filter material 32, are provided with a molded-on sealing material.

At least in the area of the largest free cross section of the filter material 32 and the support tube 28, that is, on the bottom end as shown in FIG. 1, when the filter material 32 and the support tube 28 are separated, the ring segment 54 of the lower holding part 48 which slides down at least on its free end area on the other holding part 46 and the support tube 28 is reduced relative to its wall thickness compared to the outer corresponding ring segment 54 of the holding part 48. For the lower ring segment 54 which is located on the inner peripheral side, this yields a type of slide lip 62 which, due to its elasticity in conjunction with the elastic filter material, distinctly facilitates the processes of sliding on and off for the filter material 32. Furthermore, in this area the lower free end of the lower holding part 48 for the filter material 32 sits on the annularly widened contact surface 64 of the other lower holding part 46, the other holding part 46 being detachably joined to the filter housing 10 in the area of the outflow connection 24 via a threaded segment 66 on the bottom end.

In the operation of the filter device according to the invention as shown in FIG. 1, the unfiltered fluid flows via the inflow connection 20 and the incoming channel 68 into the interior of the filter device, in normal filter operation flow through the filter material 32 taking place from the outside to the inside and then through the perforation 30 of the support tube 28. Cleaned fluid then travels via the interior of the support tube 28 and the outflow connection 24 back into the hydraulic system, here in the form of a fluid tank which is not detailed. If the filter material 32 is clogged, operation of the hydraulic system can be ensured via a bypass valve 70 which is integrated into the upper, other holding part 42 of the support tube 28. In this way passage through the filter material 32 is circumvented via the bypass valve 70.

On the top end of the filter element 26, that is, in the area of the upper end cap in the form of the upper holding part 44, it is provided with two contact crosspieces 72 against which the bottom of the housing cover 14 presses, which cover is provided otherwise on its interior with a compression spring 74 which, as is not detailed, acts on the top of the filter element 26 in order to hold it in this way in its filtration position as shown in FIG. 1. As a result of the taper of the filter element 26 for an otherwise cylindrically made housing casing 12, in this respect in the throughflow area for the unfiltered fluid there is an oppositely arranged taper which on the upper entry area of the filter device and accordingly at the inlet leads to a large annular gap 76 and on the bottom end to a small annular gap 78. The large annular gap 76 at the entry of the device has the advantage that high flow rates occur and the annular gap 78 on the filter bottom leads to a declining flow rate; this is more favorable in terms of energy viewed overall and leads to higher flow rates than if the housing parts and the filter element parts are made exclusively cylindrical, as in the known solutions in a concentric arrangement.

For a replacement process first the housing cover 14 is removed from the housing casing 12 and then the housing casing 12 with the filter element 26 is lifted as a whole, the insertion flange 16 together with the other housing parts 20, 22 remaining on the tank and its wall which are not detailed. Then retained and sedimented dirt in this way cannot reach the tank, but is properly removed from the device via the housing casing 12 and disposed of. For this purpose the housing casing 12 is supported on the other housing parts 20, 22 via a ring seal 80. Then, separation can take place from the filter material 32 to the support tube 28 by the filter material 32 with its holding parts 44, 48 being withdrawn from the support tube 28 together with the assignable holding parts 42, 46. New filter material 32 is then again slipped onto the conical arrangement of the support tube 28 with the holding parts 42, 46 and after insertion of the filter element 26 as a whole into the housing casing 12 the filter device can be reassembled in the reverse sequence for renewed use.

The other embodiment as shown in FIG. 2 corresponds in terms of its fundamental structure to the embodiment as shown in FIG. 1, so that in this respect the same reference symbols are used for the same parts as shown in FIG. 1 and the statements made so far in this respect also apply to the embodiment as shown in FIG. 2 which is only explained to the extent it differs significantly from the embodiment as shown in FIG. 1.

In the embodiment as shown in FIG. 2, the inflow connection 20 is located on the bottom end of the filter device and together with the outflow connection 24 is held in the manner of a connection block which can be connected to the housing casing 12 in terms of its top. In the embodiment as shown in FIG. 2, in the area of the largest free cross section of the filter material 32, that is, on the lower end, the assignable holding part 48 is provided with an annular holding space 82 which is used as a type of dirt catching basket. In the modified embodiment as shown in FIG. 2, for a replacement process of the filter material 32 in turn the housing cover 14 is removed from the housing casing 12 and the filter material 32 with its upper holding part 44 and with its lower holding part 48 is withdrawn from the support tube 28 with its holding parts 42 and 46, a clip part 84 which extends through the upper contact bridges 72 of the upper holding part 44 being vertically adjustable and in this way facilitating the withdrawal motion by hand. A correspondingly equipped filter material part 32 can be changed in the reverse sequence, as shown. Furthermore the holding space 82 enables retention of sedimented dirt which cannot travel unintentionally into the hydraulic system and which can be removed in this way from the filter device. In both embodiments, for the replacement process of the filter material 32, tapers which are in the range from 2° to 10°, in particular approximately 5°, have proven especially advantageous.

1. A filter device having a housing (10) consisting of at least two housing parts (12, 14) which are to be detachably connected to one another, which housing holds a filter element (26) which has a support tube (28) and a filter material (32) which surrounds the support tube (28), the ends (34, 36; 38, 40) of the support tube (28) and filter material (32) discharging into at least one holding part (42, 46; 44, 48), characterized in that the filter material (32) can be withdrawn in the direction (50) separating it from the support tube (28) and in that in this withdrawal direction (50) both the support tube (28) and also equally the filter material (32) are provided with a definable taper.

2. The filter device according to claim 1, wherein the respective end (38, 40) of the filter material is provided with a holding part (44, 48) which has two ring segments (52, 54) which border the assigned end (38, 40) of the filter material on the inner and outer peripheral side respectively.

3. The filter device according to claim 2, wherein the two ring segments (52, 54) of at least one holding part (44, 48) encompass the assigned filter material (32) by clamping it.

4. The filter device according to claim 1, wherein the ends (34, 36) of the support tube (28) are held in a further holding part (42, 46) and wherein viewed in the longitudinal direction (50) of the housing (10), the filter material (32) with its holding parts (44, 48) is axially longer than the support tube (28) which lies inside.

5. The filter device according to claim 4, wherein the respective other holding part (42, 46) with an annular flange-like extension (56) on the inner peripheral side supports the respectively free end area of the support tube (28) and wherein the ends (34, 36) of the support tube (28) adjoin the respective other holding part (42, 46) flush.

6. The filter device according to claim 2, wherein at least in the area of the largest free cross section of the filter material (32) and the support tube (28), the ring segment (54) of the holding part (48) which slides down at least on its free end area on the other holding part (46) and the support tube (28) when the filter material (32) and the support tube (28) are separated, is reduced relative to its wall thickness compared to the outer corresponding ring segment (54) of the holding part (48).

7. The filter device according to claim 6, wherein at least in the area of the largest free cross section of the filter material (32) and the support tube (28), the holding part (48) sits on an annular contact surface (64) of the other holding part (46) which is detachably connected to the housing (10).

8. The filter device according to claim 6, wherein in the area of the largest free cross section of the filter material (32) the holding part (48) has an annular holding space (82) which is used as a type of dirt catching basket.

9. The filter device according to claim 1, wherein within an incoming channel (68) of the housing (10) for unfiltered fluid the other holding part (42) is provided with a bypass valve (70).

10. A filter material for use in a filter device according to claim 1, wherein the filter material (32) forms a filter mat, preferably in pleated form, of the same wall thickness, and wherein the taper is between 2° to 10°, in particular approximately 5°.
